(19) United States
(12) Patent Application Publication
(10) Pub. No.: US 2018/0238784 A1
(43) Pub. Date: Aug. 23, 2018

(54) PLANAR TEST SYSTEM

(71) Applicant: Imperial Innovations Limited, London (GB)

(72) Inventors: Jianguo LIN, London (GB); Nan LI, London (GB); Zhutao SHAO, London (GB); Qian BAI, London (GB)

(21) Appl. No.: 15/751,605

(22) PCT Filed: Aug. 5, 2016
(86) PCT No.: PCT/GB2016/052449

§ 371 Date: Feb. 9, 2018

(30) Foreign Application Priority Data
Aug. 10, 2015 (GB) 1514084.1

(51) Int. Cl. G01N 3/04; G01N 3/18; G01N 3/10

(52) U.S. Cl. CPC G01N 3/04; G01N 3/18; G01N 3/10; G01N 2203/0016; G01N 2203/0435; G01N 2203/0026; G01N 2203/0222; G01N 2203/0254; G01N 2203/0272; G01N 2203/0282

(57) ABSTRACT

An apparatus for applying a force to a specimen is provided. The apparatus comprises: an output rotatable member comprising a plurality of connection points; a plurality of rigid connection means, each comprising a first end and a second end, wherein the first end of each connection

means is pivotably coupled to one of the plurality of connection points of the output rotatable member; a plurality of guide members; and a plurality of specimen holders, each slidably mounted to one of the guide members and pivotably coupled to the second end of one of the plurality of connection means.

### RELATED APPLICATIONS

The present application is a national stage application under 35 U.S.C. § 371 of International Application No. PCT/GB2016/052449, filed 5 Aug. 2016, and which claims priority from GB Patent Application No. 1514084.1, filed 10 Aug. 2015. The above-referenced applications are hereby incorporated by reference into the present application in their entirety.

### FIELD OF THE INVENTION

The present invention relates to an apparatus for applying a force to a specimen. In particular, but not exclusively, the present invention relates to an apparatus for applying a planar force to a specimen for use in the determination of forming limit diagrams. The present invention finds particular utility in the determination of forming limit diagrams in an isothermal environment and under complex temperature conditions that mimic hot forming and cold die quenching processes.

### BACKGROUND

The ability to easily conduct planar tests, whether tensile or compressive, is desirable for a range of different applications. Planar biaxial tests are usually conducted on biaxial test machines, often standalone machines with four independently controlled actuators. Alternatively, link mechanism attachments or rack and gear mechanisms can be mounted on conventional uniaxial machines to convert a uniaxial force to a biaxial one. However, current planar test methods often require complicated actuated mechanisms or electronics to operate; consequently, the use of such devices is often restricted to tests conducted at room temperature, as the necessary electronics may drift, or even break, in cold or hot environments.

One particular application in which a planar test system suitable for use at both hot and cold temperatures is desirable is in the determination of forming limit diagrams of materials. In particular, it is desirable to have a planar test system which is suitable for use under a range of temperatures, for example those that mimic complex material forming conditions such as hot forming and cold die quenching, when determining forming limit diagrams. A forming limit diagram (FLD) provides a graphical indication of the results of multiple material failure tests for a sheet metal. An FLD is an experimental curve which identifies the limit where an applied strain causes uniform deformation of the material and shows where plastic instability or diffuse necking, which lead to material failure, onset. The region above the curve of an FLD is considered to be the strain region where there is potential for fracture, and the region below the curve is regarded as the safe forming region where uniform deformation of the material, such as sheet metal, occurs. For example, FLDs are used by manufacturers and designers to evaluate the formability of sheet metal when it is subjected to different forming processes, and allow, for example, a prediction of the conditions at which fracture of the sheet metal will occur.

Steel has been the dominant manufacturing material for many industries due to its high strength and toughness and good formability, but lighter weight materials such as magnesium alloys or aluminium alloys are now frequently used to reduce weight, thereby improving the performance and safety of vehicles and directly reducing the energy consumption, which is beneficial to both fuel economy and the environment.

However, due to the low formability of these alloys at room temperature, a hot forming and cold die quenching (HFQ) method is now increasingly used for these materials instead of more traditional warm and hot forming processes, which can cause thermal distortion and undesirable mechanical properties in the formed components. During an HFQ forming process, a metal sheet is heated up to a specific temperature in a solution to heat treat the metal, before being transferred to a cold die and stamped. The metal is then held in the tool until it is quenched. The HFQ method allows the formation of components with a complex shape, whilst minimising thermal distortion.

As the formability of a sheet metal is dependent on both intrinsic parameters (such as the mechanical behaviour and microstructure of a material and its constitutive properties) as well as extrinsic factors (i.e. forming conditions, such as temperature, strain rate, strain path and tooling), the FLD of a sheet metal at elevated temperature can be significantly different to that obtained at room temperature. It is therefore useful to know the failure limits of the material being formed under applicable forming conditions. However, FLD determination typically occurs at room temperature (for example following the international standard ISO 12004-1:2008 for FLD determination), or under warm or hot forming processes; there are no method standards for determining FLDs at conditions applicable to HFQ processes, nor are there any suitable test methods.

Neither of the two main methods of determining FLDs currently used—out-of-plane tests and in-plane tests—are suitable for use at HFQ conditions, which generally comprise subjecting the sheet metal, or other material, to a heating process, a cooling process, and deformation under elevated temperatures and at a constant strain rate.

Out-of-plane tests involve stretching sheets of metal of varying dimensions by applying a force through a rigid punch or hydraulic means. However, forming limit diagrams determined by this method exhibit a dependence on the thickness of the metal sheet and the dimensions of the punch used to deform the sheet. This is due in part to the fact that the effect of friction between the sheet metal and the testing components cannot be avoided, even if lubricants are used. Furthermore, large strain gradients are produced in the metal when this method is used, and the deformation strain rate is not constant. Moreover, the punch and dies used to perform the out-of-plane tests are not strong enough to withstand the high temperatures required to test, for example, boron steels at elevated temperatures or under HFQ process conditions.

In-plane tests involve stretching the sheet metal over a flat bottomed punch of cylindrical cross-section (or stretching the metal using hydraulic means). Using this method, the central area of the sheet metal can be deformed with a uniform and proportional strain path, without any bending in the centre of the sheet metal where the measurement occurs. A carrier blank with a central hole is often used to avoid frictional contact between the sheet metal specimen and the punch, and any localised thinning or fracture of the sheet metal should occur in the region of the sheet metal unsupported by the carrier blank. However, forming limit diagrams determined using this method are sensitive to material defects, surface quality and the selection of carrier blank size. Furthermore, optimising the dimension and geometry of the carrier blank and punch is necessary to induce strain localisation and cracking in the region of the sheet metal specimen unsupported by the carrier blank, which complicates the test procedure and increases the cost. Like the out-of-plane method, the in-plane test method is also not applicable under HFQ process conditions.

There is therefore a need for an apparatus and method for determining the FLD of a sheet metal which overcome the difficulties associated with standard tests and can be used under HFQ conditions, in order to facilitate the testing of the sheet metal under conditions relevant to a range of material forming processes.

### SUMMARY

According to a first aspect, there is provided an apparatus for applying a force to a specimen, comprising:
an output rotatable member comprising a plurality of connection points;
a plurality of rigid connection means, each comprising a first end and a second end, wherein the first end of each connection means is pivotably coupled to one of the plurality of connection points of the output rotatable member;
a plurality of guide members; and
a plurality of specimen holders, each slidably mounted to one of the guide members and pivotably coupled to the second end of one of the plurality of connection means.

The apparatus of the first aspect can be used to apply a multiaxial, such as a biaxial, force to a specimen. A rotation of the output rotatable member causes each of the specimen holders to slide along one of the guide members, due to the pivoting of the rigid connection means coupled between the output rotatable member and the specimen holders. When the apparatus is in use with a specimen, the rotation of the output rotatable can affect a planar force on the specimen, either tensile or compressive, depending on the direction of rotation.

Advantageously, when the apparatus is in use with a specimen, a strain rate can be adjusted by altering a rate of rotation of the output rotatable member, and a variety of different strain paths can be realised in the specimen by altering which, if any, of the plurality of connection points the rigid connection means are coupled to. The strain path can also be changed by altering the lengths of the plurality of connection means. For example, each of the plurality of connection means can be a different length. The apparatus can be configured to apply a variety of different strain paths to a specimen. Five strain paths that can applied by the apparatus, which are those typically used to determine a forming limit diagram (FLD), are: uniaxial; uniaxial to plane strain; plane strain; plane stain to biaxial; and biaxial. In particular, the apparatus can be configured to apply the uniaxial, plane strain and biaxial strain paths which are critical to the determination of an FLD.

Preferably, the force applied to the specimen is biaxial, though optionally the force can be another multiaxial force or a uniaxial force, depending on the particular arrangement of the rigid connection means to the plurality of connection points and the length of the connection means themselves. The apparatus can convert an input uniaxial or rotational force into an output multiaxial, such as biaxial, force. Advantageously, the apparatus can facilitate the use of a conventional uniaxial tensile or compression machine for the application of a biaxial force to a specimen. This may reduce the cost and complexity of biaxial force tests compared to traditional biaxial testing mechanisms. Furthermore, the apparatus is advantageous as it can be much smaller than other link mechanisms with a similar loading capacity.

This architecture facilitates a planar force application to a specimen and the realisation of multiple strain paths in said specimen. The apparatus may therefore advantageously be used to determine forming limit diagrams (FLDs), overcoming the problems associated with the traditional FLD determination methods described above. For example, the apparatus of the first aspect can enable material testing in which the strain path is independent of the dimensions of the specimen, and can prevent friction effects influencing the test results. The apparatus can also be used to investigate the mechanical behaviour of materials (such as fatigue, creep, elasto-plastic behaviour, yield criteria or hardening laws). Advantageously, the apparatus of the first aspect can be a simpler and cheaper device than traditional biaxial planar test devices.

Advantageously, the apparatus can facilitate a more accurate testing of materials by enabling the application of equal force to each end of a specimen. Many conventional biaxial machines only use two actuators, rather than four, and therefore the central point of the specimen changes as deformation of the sample occurs during tension tests. This can affect the accuracy of the obtained results. The apparatus of the first aspect can help overcome this problem by enabling the application of force to all ends of a specimen to ensure uniform deformation, without the cost of four separator actuators.

Optionally, the apparatus can further comprise a drive shaft coupled to the output rotatable member. This can facilitate the rotation of the output rotatable member by, for example, a motor or other driving force. Optionally, the apparatus further comprises an input rotatable member coupled to the drive shaft.

Optionally, the apparatus further comprises a rigid drive member arranged to rotate the output rotatable member. This arrangement can facilitate the use of the apparatus with a conventional uniaxial test machine or any other source of uniaxial force. A linear force can be applied to the rigid drive member, which is arranged to rotate the output member, thus converting the linear motion into a biaxial one. The rigid drive member can be directly coupled to the output rotational member or indirectly coupled to it. For example, the rigid drive member may be coupled to the drive shaft or input rotational member and arranged to rotate the drive shaft in order to rotate the output rotatable member.

In preferred embodiments, the output rotatable member is a disc shape. This architecture facilitates a lighter and more compact apparatus. Preferably, the connection points are distributed in a plane of the output rotatable member. When the output rotatable member is a disc, the connection points are distributed in a plane of the disc. Alternatively, the connection points may be distributed in a plane of any other shape of output rotatable member. Preferably, the connection points are distributed on a planar surface of the output rotatable member to facilitate easier coupling of the rigid connection means to the connection points and the application of a planar force.

In preferred embodiments, the plane of the output rotatable member is perpendicular to an axis of rotation of the output rotatable member. Preferably, each of the plurality of guide members extends in a direction perpendicular to an axis of rotation of the output rotatable member. More preferably, each guide member extends perpendicular to the guide members adjacent to it. In preferred embodiments, the plurality of guide members define a plane parallel to the plane of the output rotatable member. This architecture is advantageous as it can facilitate a compact apparatus in which a biaxial force is applied to a specimen in a planar orientation. This is important for the determination of forming limit diagrams, as any bending of the specimen can affect material test. Furthermore, the application of force in a planar orientation can reduce fatigue of the components of the apparatus by preventing torsional forces.

Optionally, each guide member comprises two rails orientated parallel to one another. This arrangement can facilitate an improved stability of the specimen holders by supporting the specimen holders along more of their width, whilst reducing the weight of the apparatus compared to an equivalent guide member formed of a single piece.

The apparatus of the first aspect is advantageous as it has a relatively simple configuration and is employable within the limited space available on conventional test machines. Furthermore, the effective strain rate of deformation of the specimen is constant during the test due to the planar configuration of the apparatus. Additionally, friction effects between the apparatus and the specimen, which are a problem with conventional methods of determining FLDs, are avoided.

Preferably, the apparatus can be used in a system comprising a specimen, wherein the plurality of specimen holders hold the specimen. Optionally, the system further comprises an environmental chamber housing the apparatus. Preferably, the system further comprises a temperature control for controlling a temperature of the specimen. The temperature control can control the temperature of the specimen itself, or the ambient temperature inside the environmental chamber.

This arrangement can facilitate the determination of forming limit diagrams (FLDs) by enabling not only the heating and cooling of the specimen in a way that mimics HFQ forming processes, but also the subsequent maintenance of an isothermal temperature throughout the specimen whilst material stretching tests are carried out on the specimen using the apparatus. When the apparatus is housed in the environmental chamber, this can be achieved by maintaining an isothermal environment within the environmental chamber. Alternatively, in embodiments comprising an environmental chamber, the environment within the chamber is uncontrolled and the temperature of the specimen is directly controlled.

Preferably, the temperature control is configured to control a heating rate of the specimen and a subsequent cooling rate of the specimen in order to simulate hot forming and cold quenching of the specimen within the environmental chamber. This is advantageous as it can facilitate the determination of FLDs of sheet metal, represented by the specimen, at conditions applicable to the forming processes used on sheet metal in manufacturing. This can ensure that the determined FLDs reflect the behaviour of the sheet metal, reducing material wastage from fracture and failure of the sheet metal during manufacturing and thus reducing costs.

Optionally, the system further comprises a measurement system configured to measure a strain in the specimen and/or a force applied to the specimen. Optionally, the system comprises at least one sensor configured to sense the force applied to the specimen. In some embodiments, the force sensor is integrated into the plurality of sliding elements of the apparatus and configured to sense the force applied to the specimen. Optionally, the system comprises a sensor configured to sense the strain in the specimen. For example, the sensor configured to sense the strain could be a sensor configured to perform digital image correlation, for example a camera. Measurement of the force and/or the strain can enable the determination of the necessary data points for creating an FLD for the sheet metal represented by the specimen.

According to a second aspect, there is provided a method for applying a force to a specimen, comprising:
providing an apparatus, the apparatus comprising:
   an output rotatable member comprising a plurality of connection points,
   a plurality of rigid connection means, each comprising a first end and a second end, wherein the first end of each connection means is pivotably coupled to one of the plurality of connection points of the output rotatable member,
   a plurality of guide members, and
   a plurality of specimen holders, each slidably mounted to one of the guide members and pivotably coupled to the second end of one of the plurality of connection means;
providing a specimen, wherein the plurality of specimen holders hold the specimen;
rotating the output rotatable member to apply a force to the specimen.

The apparatus of the second aspect may comprise any of the features of the apparatus of the first aspect, either alone or in combination with each other. The specimen holders may hold the specimen by way of a clamp or grip. Alternatively, the specimen may be fixed to the specimen holders by way of fixing means, for examples screws, bolts or pins. Preferably, the shear strength of the fixing means should be greater than the force applied to the specimen by the apparatus.

In preferred embodiments, the step of rotating comprises applying a linear force to a rigid drive member arranged to rotate the output rotatable member. For example, the output rotatable member may be rotated by a conventional uniaxial test machine in order to apply a biaxial tensile or compressive force to the specimen, depending on the direction of rotation of the output rotatable member.

Preferably, the method further comprises the step of controlling a temperature of the specimen. Optionally, when the apparatus is housed in an environmental chamber, controlling a temperature of the specimen can comprise controlling the temperature within the environmental chamber containing the specimen or controlling the temperature of the specimen directly. When the apparatus and specimen are used in the absence of an environmental chamber, the step of controlling the temperature comprises controlling the temperature of the specimen directly. Heating or cooling the specimen directly is advantageous as the apparatus can be at room temperature during the forming limit diagram determination, and therefore the effect of elevated temperature or cold quenching on the strength of the components of the apparatus does not need to be considered.

Preferably, controlling the temperature of the specimen comprises controlling a heating rate of the specimen and a subsequent cooling rate of the specimen, in order to simulate hot forming and cold quenching of the specimen within the environmental chamber. Preferably, the method further comprises measuring a strain in the specimen and/or a force applied to the specimen. The apparatus of the first aspect facilitates determining the time-dependent strain and deformation history of the specimen, which is very difficult to do using conventional out-of-plane and in-plane FLD determination methods. Therefore, the method of the second aspect can facilitate the accurate determination of the FLD of sheet metal under conditions applicable to the hot forming and cold quenching processes with which the sheet metal is typically subjected during manufacture.

Furthermore, the method is advantageous because it can be used to determine the FLD of a wide range of sheet metals including, but not restricted to, aluminium alloys, magnesium alloys and boron steels. Advantageously, the same apparatus and method can be used without modification for any material; only the specimen itself needs to be changed.

### BRIEF DESCRIPTION OF THE DRAWINGS

Embodiments of the present invention will now be described with reference to the accompanying drawings, in which:

FIG. 1A is a top view of an apparatus according to a preferred embodiment of the present invention;

FIG. 1B is a side view of the apparatus of the preferred embodiment shown in FIG. 1 taken along line A-A;

FIG. 2 is a bottom view of the apparatus according to the preferred embodiment of the present invention;

FIG. 3 is a top view of a specimen for use with the apparatus;

FIG. 4 is a perspective view of the apparatus of the preferred embodiment of the present invention together with the specimen shown in FIG. 3;

FIG. 5 is a schematic illustration of a system including the apparatus according to an embodiment of the present invention;

FIG. 6A is a perspective view of the apparatus illustrating the position of the components of the apparatus at a first point during operation of the apparatus;

FIG. 6B is a perspective view of the apparatus illustrating the position of the components of the apparatus at a second point during operation of the apparatus; and

FIGS. 7A to 7E illustrate different modes of operation of the apparatus of the preferred embodiment.

### DETAILED DESCRIPTION

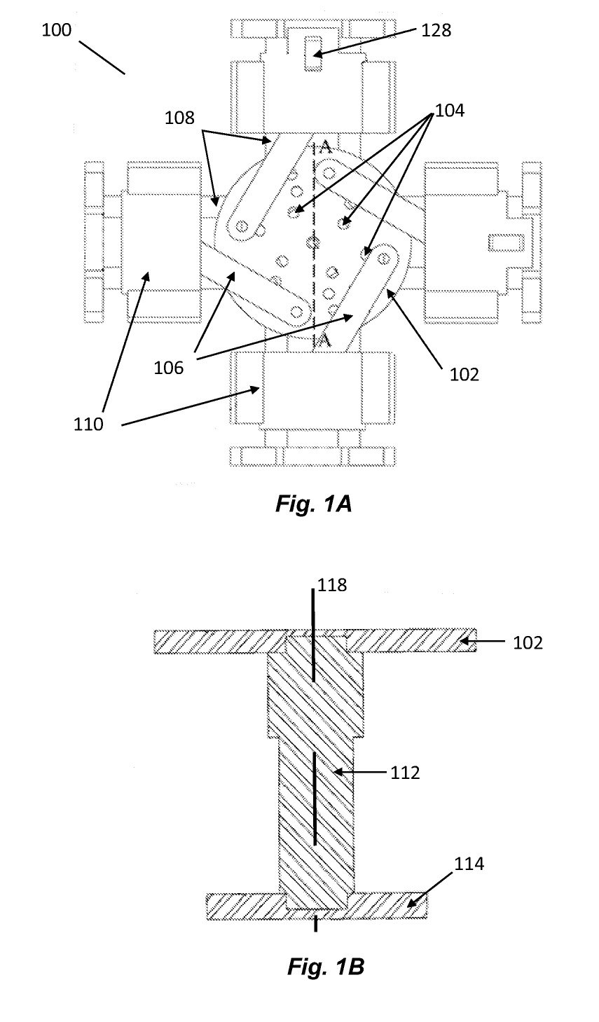

With reference to FIG. 1A, a top view of a biaxial force apparatus 100 according to a preferred embodiment is shown. The apparatus 100 comprises an output rotatable member 102, a plurality of connection points 104, a plurality of rigid connection means 106, a plurality of guide members 108 and a plurality of specimen holders 110. The apparatus 100 is designed to apply a biaxial force to a specimen (not shown), which is held in place by the plurality of specimen holders 110. The apparatus 100 can be formed to be small in dimension; for example, the apparatus can be 250 mm×250 mm×100 mm with a load capacity of 80 kN. Alternatively, the apparatus could be larger than this in order to accommodate more substantial material specimens, or the apparatus could be formed smaller than the above dimensions. The load capacity of the apparatus is dependent on the strength of the components in the apparatus.

In the preferred embodiment of the apparatus 100 there are four specimen holders 110, each mounted on one of four guide members 108. The specimen holders 110 are arranged in two pairs. Each pair of specimen holders 110 is arranged along an axis, and the axes along which each of the two pairs of specimen holders 110 lies are orthogonal to one another. Each of the four guide members 108 extends perpendicular to the two guide members adjacent to it. The four guide members 108 are arranged to lie in a plane parallel to a plane defined by the axes of alignment of the specimen holders 110. This arrangement facilitates the application of a planar, biaxial, force to a specimen; each pair of specimen holders 110 can apply a force to a specimen along a single axis when the apparatus is in use.

In this preferred embodiment, each of the plurality of guide members 108 comprises two rails, which are aligned parallel with one another. The specimen holders 110 are slidably mounted on the respective guide members 108 such that they can slide back and forth along the rails of the guide member with very low friction. In other embodiments, each of the guide members may comprise only one rail, or may comprise more than two rails. Alternatively, the guide members 108 may be any other geometry which facilitates the sliding of the specimen holders 110.

In the preferred embodiment, the output rotatable member 102 is formed to have a disc shape, with the plurality of connection points 104 distributed in a plane on a surface of the disc. In this embodiment, there are at least four connection points. Each of the plurality of rigid connection means 106 are pivotably coupled at a first end to one of the connection points 104 and at a second end to one of the specimen holders 110. Clearly, in this preferred embodiment there are four rigid connection means 106. The connection points 104 can be threaded holes, for example for receiving bolts or screws, or unthreaded holes for push fastenings. Alternatively, any other form of connection points suitable for pivotably coupling a rigid connection means to the output rotatable member can be used.

In some embodiments, there may only be two specimen holders and two connection means and the apparatus may be arranged to apply a uniaxial force rather than a biaxial one. Alternatively, the apparatus may have any other number of specimen holders and connection means necessary to apply the desired strain path to a specimen.

Preferably, there are more connection points than connection means, such that the connection means can be configured in different arrangements by connecting the connection means to different of the plurality of connection points in order to achieve the desired strain path. For example, uniaxial, uniaxial to plane strain, plane strain, plane stain to biaxial, and biaxial strain can all be achieved with the apparatus by adjusting which of the plurality of the connection points the connection means are coupled to. For example, as shown in FIG. 1A, the plurality of connection points 104 are distributed across the output rotatable member 102; more connection points 104 are provided than there are connection means 106, enabling the configuration of the connection means 106 to be altered.

With reference to FIG. 1B, a side view of the apparatus 100 of the preferred embodiment is shown. It can be seen from FIG. 1B that the apparatus 100 further comprises a drive shaft 112 and an input rotatable member 114. The output rotatable member 102 is coupled to the drive shaft 112, which is in turn coupled to the input rotatable member 114. The drive shaft 112 has an axis of rotation 118 which is orientated perpendicular to the plane of the output rotatable member 102 in this preferred embodiment. The plane of the output rotatable member 102 is also parallel to the plane in which the guide members 108 extend.

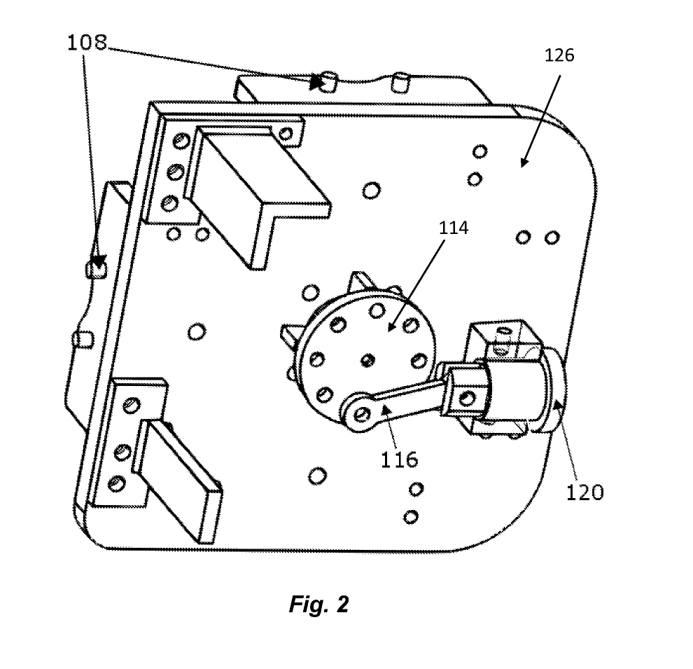

FIG. 2 shows a perspective view of the apparatus 100, illustrating the input force mechanism of this embodiment. With reference to FIG. 2, it can be seen that the apparatus 100 is further provided with a rigid drive member 116. A first end of the rigid drive member 116 is pivotably coupled to the input rotatable member 114 and a second end of the rigid drive member 116 is coupled directly to a movable jaw 120 of a uniaxial test machine. The jaw 120 is not part of the apparatus 100.

In use, the movable jaw 120 moves in a linear fashion and displaces the drive member 116. The displacement of the drive member 116 rotates the input rotatable member 114, which in turn rotates the drive shaft 112. The drive shaft 112 rotates around the axis of rotation 118, thereby rotating the output rotatable member 102 to which it is coupled around the axis of rotation 118. This causes the rigid connection means 106 to push the plurality of specimen holders 110 away from the axis of rotation 118, or pull the specimen holders 110 towards the axis of rotation 118, depending on the direction of rotation of the output rotatable member 102. In this preferred embodiment, the drive shaft 112, output rotatable member 102 and input rotatable member 114 all rotate around the axis of rotation 118.

In other embodiments, the output rotatable member can be driven by a different mechanism. For example, the drive member may be coupled directly to the output rotatable member and driven by the moving jaw 120. Alternatively, the drive member can be driven by a different mechanism. In still other embodiments, the apparatus may not comprise a drive member arranged to drive the output rotatable member; instead the output rotatable member can be driven by another means, for example a motor may be arranged to turn the drive shaft directly.

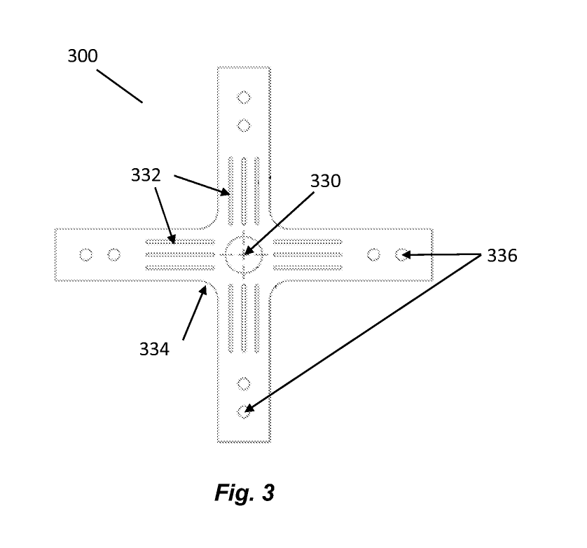

With reference to FIG. 3, an exemplary specimen 300 for use in combination with the apparatus 100 has a cruciform shape. This facilitates attachment of the specimen to the perpendicularly orientated pairs of specimen holders 110 of the preferred embodiment of the apparatus. The specimen 300 has fillets 334 to reduce stress concentrations in the corners of the cruciform and slots 332 which act to distribute the applied load more uniformly to the test area 330. The thickness (gauge) of the test area 330 is reduced to ensure that the major plastic deformation, such as necking or fracture, induced during use of the apparatus with the specimen occurs in the test area 330 of the specimen 300. A different geometry and material of specimen can be used for determining the forming limit diagram of different metals.

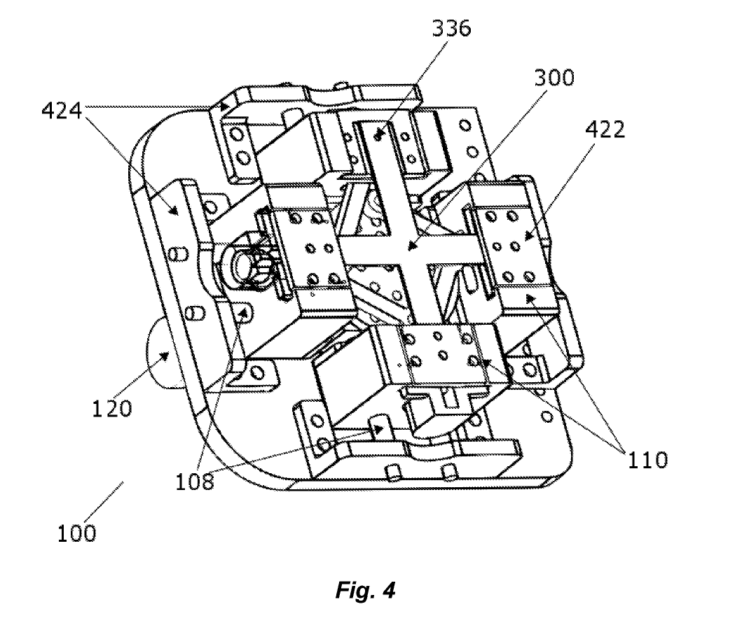

The specimen 300 attaches to the specimen holders 110 via attachment means 336. The attachment between the specimen 300 and the specimen holders 110 is described with reference to FIG. 4. In the embodiment shown in FIG. 4, each of the specimen holders 110 comprises a top plate 422. The specimen 300 is placed under the top plate 422 and the top plate 422 is fixed to the body of the specimen holders 110 such that the fixing means pass through the attachment means 336 of the specimen 300. The fixing means can be bolts or screws or any other suitable fixing means. In other embodiments the specimen holders 110 may not comprise a top plate 422 and may instead hold the specimen 300 by means of a clamp or grip arrangement. Alternatively, any other suitable means of securing the specimen to the specimen holders can be used so long as they allow a deforming force to be applied to the specimen 300.

The apparatus 100 can further comprise stops 424 which limit the displacement of the specimen holders 110 along the guide members 108. Therefore, the length of the rigid connection means 106 and their connection points 104 should be adjusted such that the required strain and strain paths are produced within the specimen 300 within the limited range of motion of the specimen holders 110; after the specimen holders 110 reach the stops 424, no more force can be applied to the specimen 300 by the apparatus in order to deform it.

The apparatus can further comprise a base plate 126. The base plate 126 can be a rigid plate to which components of the apparatus such as the stops 424 and/or guide members 108 can be securely attached. The base plate 126 preferably has further fixing points to fix, for example, the specimen holders 110 in order to prevent them sliding along the guide members 108. For example, the base plate may comprise a plurality of fixing points arranged such that each of the specimen holders can be coupled to one (or more) fixing point. This arrangement can be useful for the creation of different strain paths in the specimen. One or more specimen holders may be coupled to the fixing points. Alternatively, when a biaxial strain path is applied, none of the specimen holders are coupled to the base plate. It is to be understood that when all of the specimen holders are coupled to the base plate, the specimen holders will not slide along the guide members and thus no force would be applied to the specimen held by the specimen holders. The specimen holders 110 may have threaded holes in them to facilitate bolting or screwing of the specimen holders 110 to the base plate 126. Alternatively the specimen holders 110 may be attached to the base plate 126 by any other suitable fixing means.

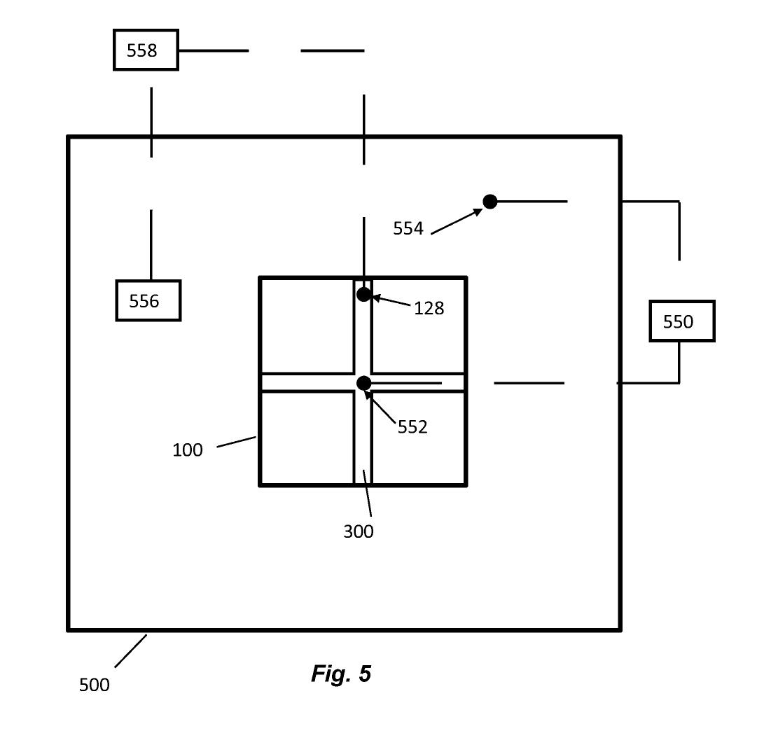

In some embodiments, a system is provided in which the apparatus 100 described above is housed in an environmental chamber 500, as shown in FIG. 5. Optionally, the system may further comprise one or both of a temperature feedback control system 550 and a measurement system 558. The environmental chamber 500 provides an isothermal environment in which deformation of the specimen 300 can occur. Commercial environmental chambers can be used. The temperature within the environmental chamber can be controlled, or the temperature of the actual specimen within the environmental chamber can be controlled independently of the ambient temperature within the environmental chamber.

In other embodiments, the apparatus is not housed in an environmental chamber as shown in FIG. 5. Instead, a system is provided comprising the apparatus 100 and the specimen 300, where the specimen is held in place by the specimen holders 110. The temperature of the specimen 300 can be controlled such that the temperature of the specimen is isothermal after temperatures mimicking the heating and cooling processes experienced during material formation by HFQ, for example, have been applied to the specimen.

A closed loop temperature feedback control system 550 can be used to control the temperature of the specimen itself (both when the specimen is in the environmental chamber and when it is not) or to control the temperature within the environmental chamber. For example, a thermocouple or other temperature sensor 552, such as an infrared pyrometer, can be integrated into the specimen 300 or placed in the vicinity of the specimen 300. The sensing result of the temperature sensor 552 can feed back into the temperature control system 550, and the temperature can be adjusted based on the sensing result. Alternatively, or additionally, a temperature sensor 554 can be used to sense the ambient temperature inside the environmental chamber 500. The sensing result of temperature sensor 554 can feed into the temperature control system 550 and the temperature within the chamber 500 can be adjusted accordingly.

In some embodiments, an automatic, electronic control system can be used to program or otherwise define a temperature profile. This can be integrated into the temperature feedback control system 550 described above. Comparison between a programmed temperature and the temperature sensing results can be used to automatically adjust the input to the temperature control so that the temperature of the specimen is adjusted in accordance with the programmed temperature. For example, the temperature control system 550 can replicate the temperatures, and temperature variations, experienced during a hot forming and cold quenching manufacturing process. In this way, the temperature history of the specimen can be controlled.

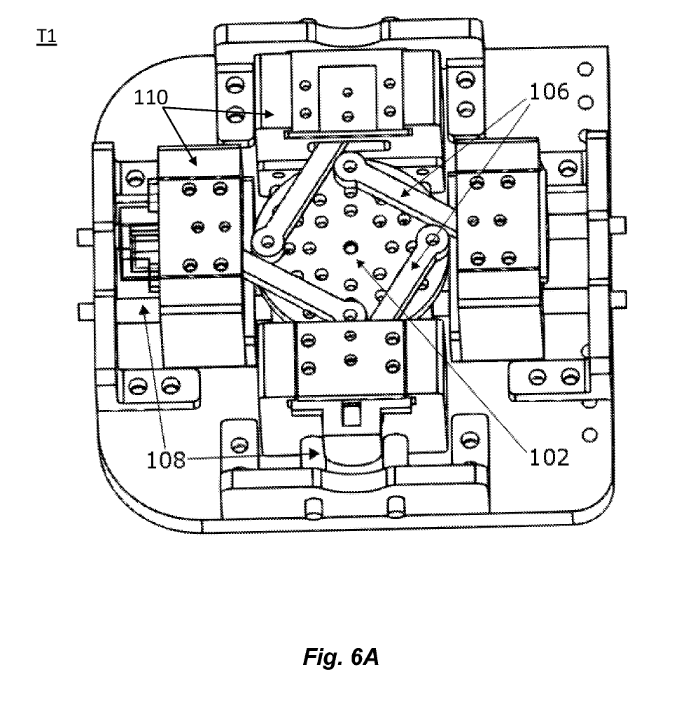

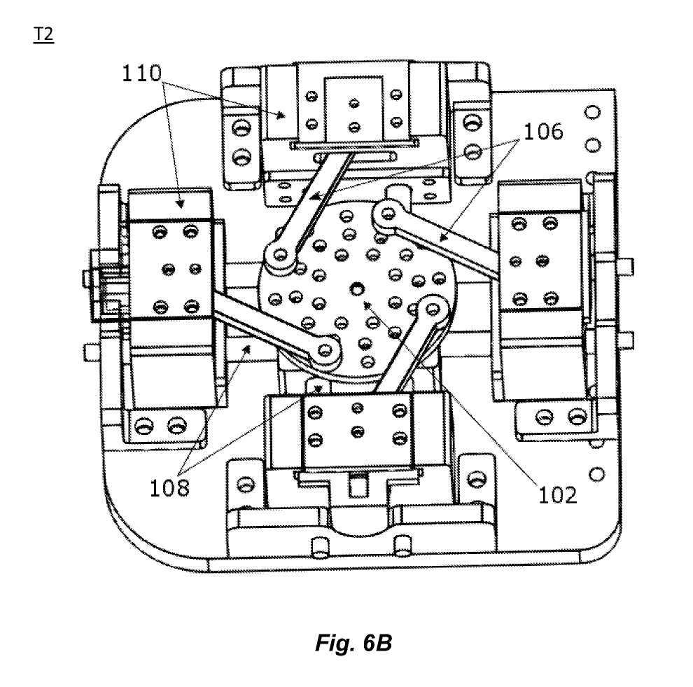

A method of using the apparatus 100 to apply a biaxial force to a specimen is described with reference to FIGS. 6A and 6B. FIG. 6A shows the position of the components of the apparatus 100 at a first point in time, T1. In use, a specimen, for example the specimen described above with reference to FIG. 3, would be provided in the specimen holders 110, as shown in FIG. 4 for example.

In the preferred embodiment, the output rotatable member is rotated by means of a uniaxial force applied to the drive member 116. The uniaxial force is provided by the linear displacement of the movable jaw 120 of a conventional uniaxial test machine. This uniaxial force rotates the input rotatable member 114, which in turn rotates the drive shaft 112 to which it is coupled. As the drive shaft rotates, it rotates the output rotatable member to which it is also coupled. All three of these components rotate around the rotational axis 118. At a time T2, shown in FIG. 6B, the output rotatable member 102 has rotated approximately 30 degrees around the axis of rotation 118 from its position as shown in FIG. 6A at a time T1. The rotation of the output rotatable member 102 causes the rigid connection means 106, which are pivotably coupled to the connection points 104 of the output rotatable member 102, to slide the specimen holders 110 along the guide members 108. This movement causes a force to be applied to the specimen fixed to the specimen holders 110.

Point T2 can be earlier or later in time than point T1. If the output rotatable member 102 rotates clockwise around the axis of rotation 118 (when the apparatus is viewed from above as in FIG. 6A), T2 is later in time than point T1 and the force applied to the specimen is tensile. Alternatively, if the output rotatable member 102 rotates anti-clockwise around the axis of rotation 118, T2 is earlier in time than point T1 and the force applied to the specimen is compressive.

When the apparatus 100 is integrated into the system described with reference to FIG. 5, information regarding material failure can be obtained by applying a biaxial, planar, force to the specimen 300 by the method described above (with reference to FIGS. 6A and 6B) after the specimen has been heated and cooled to mimic the hot forming and cold quenching manufacturing process. Tests to determine the forming limit diagram can then be conducted at a constant, elevated, specimen temperature; the temperature of the specimen is controlled by the temperature control system 550 as described above with reference to FIG. 5.

The specimen 300 can be directly heated by a variety of methods. For example, one or more of the following methods of heating the specimen 300 can be used: resistance heating, in which an electric current is applied to the specimen through two electrodes; induction heating in which an electromagnetic field is used to heat the specimen through eddy currents generated in the specimen; and thermal conduction heating in which the specimen is heated by direct contact with a thermally conductive material. The thermally conductive material can be heated by a furnace or by any other method. Alternatively, any other possible method of heating the specimen can be used.

Methods of cooling the specimen 300 could comprise one or more of convection cooling or conduction cooling, though the cooling of the specimen 300 is not limited to these methods. The cooling rate must be rapid, as this is a critical condition for the hot stamping and cold die quenching process. In convection cooling, the specimen is exposed to a controlled stream of air, gaseous coolant, water or mist spray; this is a simple but unreliable method of cooling. In conduction cooling, the specimen is in direct contact with a thermal conductive material so that thermal conduction occurs away from the specimen and into the thermally conductive material.

The force applied to the specimen 300 during operation of the apparatus 100 is measured by a force sensor. The force sensor 128 can be embedded into one of the plurality of specimen holders 110, as shown in FIGS. 1 and 5 for example. Alternatively, the force sensor 128 can be located anywhere else in the system suitable for determining the force applied to the specimen.

The arrangement of the specimen holders 110 into two pairs of opposing specimen holders, where each pair is orientated perpendicular to the other pair and all four specimen holders are arranged in a plane, facilitates the application of a force to each end of the specimen 300 when the apparatus 100 of the preferred embodiment is in use. As each specimen holder 110 can be configured to displace an equal distance along the guide members 108 when the output rotatable member 102 is rotated, each end of the specimen 300 is pushed or pulled (depending on whether the apparatus is operating in compression or tension) an equal distance in each direction by the sliding specimen holders 110 by which it is held. Therefore, strain rate is uniform and the central test area 330 remains located at the centre of the specimen 300, even during the deformation of the specimen 300.

Furthermore, this arrangement can facilitate the application of a constant strain rate to the specimen 300, if the output rotatable member 102 is rotated at a constant speed. The strain undergone by the specimen 300 during the operation of the apparatus 100 is calculated using a strain sensor 556. In preferred embodiments, the strain sensor 556 uses digital image correlation (DIC). A (stochastic) speckle pattern can be sprayed onto the test area 330 of the specimen 300 before deformation, and a camera used to track the subsequent movement of the speckles in the pattern during deformation of the specimen. Images from the camera can then be analysed to determine the deformation history of the material specimen. Alternatively, the strain sensor 556 can be another kind of sensor, for example one or more linear potentiometers arranged to measure displacement of an edge or edges of the specimen.

The planar testing arrangement provided by the apparatus of the preferred embodiment facilitates the recording of the entire deformation history of the specimen; in contrast, time-dependent measurement of the strain in the specimen is very difficult to measure using conventional out-of-plane and in-plane methods.

Any other suitable methods of determining force and/or strain rate can also be used. The sensing results of the force sensor 128 and/or the strain sensor 556 are measured by the measurement system 558 during the specimen deformation process in which a planar, biaxial force is applied by the apparatus 100 of the preferred embodiment. This facilitates the determination of forming limit diagrams of the specimen material under conditions which mimic the manufacturing processes of the sheet metal.

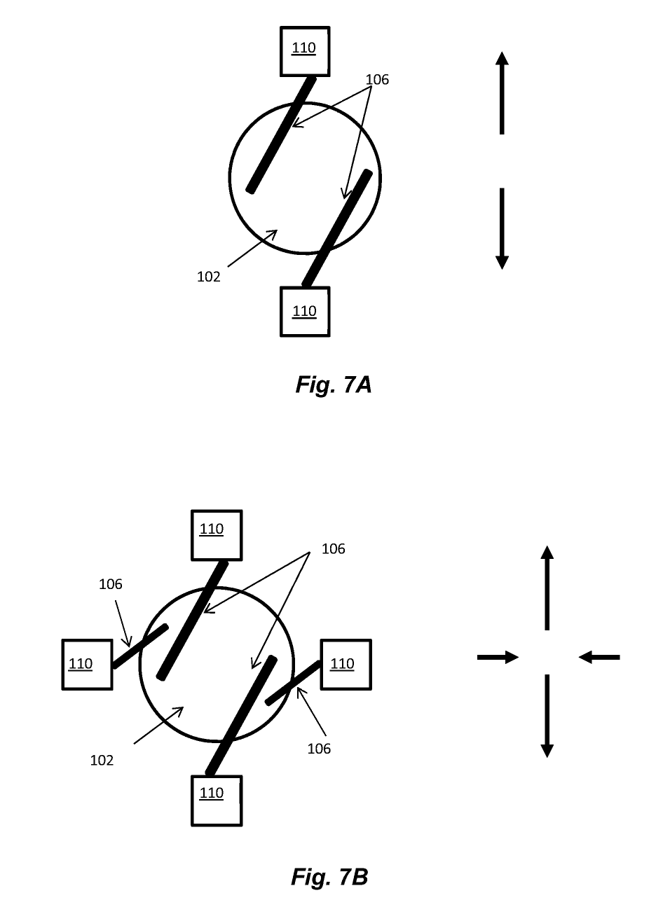

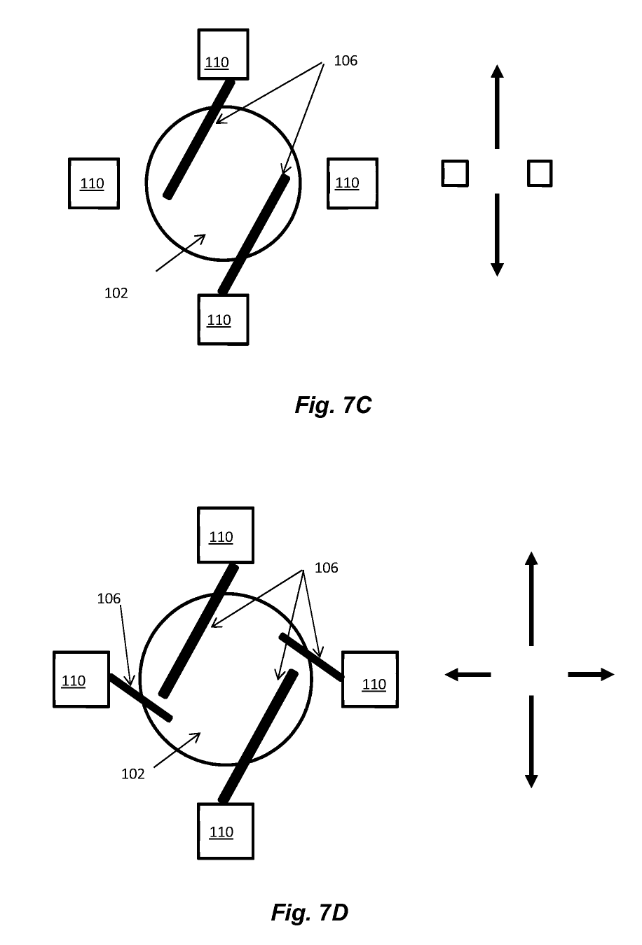

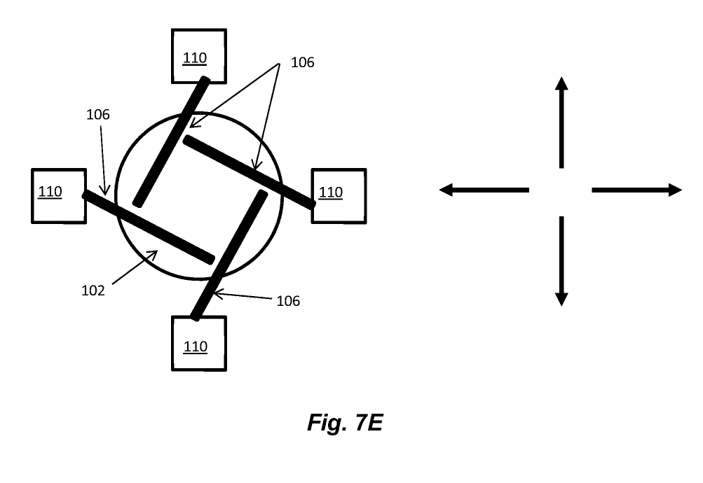

As mentioned above, the apparatus 100 of the preferred embodiment can be used to apply different strain paths to the specimen 300 by varying the length and connection points of the connection means 106. These different strain paths—uniaxial, uniaxial to plane strain, plane strain, plane strain to biaxial, and biaxial—are described below with reference to FIGS. 7A-7E. Each of FIGS. 7A-E shows a schematic of the apparatus 100 for each of the strain paths (on the left) and the direction of the forces experienced by the specimen 300 (on the right). In these examples, an end of the specimen 300 (not shown) is held by each of the specimen holders 110 shown in FIGS. 7A to 7E.

To achieve uniaxial strain, two opposing specimen holders are disconnected from the output rotatable member 102 and the specimen is held only by the other two opposing and connected specimen holders 110 which are each connected to the output rotatable member by a connection means. Therefore, when the apparatus is in use and the output rotatable member 102 is rotated, a force is only applied to two opposing ends of the specimen (as shown in FIG. 7A).

Plane strain can be achieved by fixing the two disconnected specimen holders to the base plate 126. The specimen holders 110 can be fixed by bolts or screws or other fastening means. The disconnected specimen holders 110 could also be fixed any other way that prevents them from sliding along the guide members 108; for example, they could be fixed to the guide members 108 themselves. The two connected specimen holders 110 are still free to slide along the guide members, as in the application of uniaxial strain. However, to form a plane strain path, the specimen is held in place by all four specimen holders 110. Therefore, the specimen is prevented from deforming in the same way as in the uniaxial strain scenario (FIG. 7C), for example, thinning of the specimen in the direction perpendicular to the direction of applied force is prevented by the opposing pair of fixed specimen holders 110. In plane strain, the tensile force applied to the specimen by the fixed specimen holders 110 counteracts thinning of the specimen in the direction perpendicular to the two connected and sliding specimen holders.

For biaxial force, all four specimen holders 110 are connected to the output rotatable member 102, preferably with connection means 106 of equal length, and each specimen holder 110 holds an end of the specimen (FIG. 7E).

A capability of the invention is shown in FIG. 7B. All four specimen holders 110 are connected to the output rotatable member 102 and each specimen holder 110 holds an end of the specimen. However, the lengths and orientations of the connection means 106 are adjusted so that the specimen is prevented from stretching as much as in the uniaxial case of FIG. 7A, but without two of the four ends of the specimen being held fixed, as in the plane strain case. For example, a first pair of opposing connection means 106 are shorter than a second pair of opposing connection means 106 and are orientated in the opposite direction to the first pair in order to control compression of the specimen when the second pair applies a tensile force to the specimen (FIG. 7B).

The intermediate strain paths between plane strain and biaxial strain and between uniaxial and plane strain are shown in FIG. 7D. All four specimen holders 110 are connected to the output rotatable member 102 and each specimen holder 110 holds an end of the specimen. However, the lengths and orientations of the connection means 106 are adjusted to apply an unequal tensile biaxial force in orthogonal directions. For example, a first pair of opposing connection means 106 are shorter than a second pair of opposing connection means 106 (FIG. 7D). In the uniaxial to plane strain case, the tensile force applied to the specimen by two opposing specimen holders 110 is less than the force required to prevent thinning of the specimen due to the displacement of the other two opposing specimen holders 110. The overall force on the specimen is therefore compressive along one axis and tensile along another axis. In the plane to biaxial strain case, the force applied by one pair of opposing specimen holders 110 to the specimen is less than that applied by the other pair of opposing specimen holders 110 but more than the force required to prevent thinning of the specimen. The force on the specimen is then tensile in all directions. Different connection points and different lengths of connection means are used to achieve these two different intermediate strain paths.

As illustrated by FIGS. 7A to 7E, to achieve two or more of the above strain paths (uniaxial, uniaxial to plane strain, plane strain, plane strain to biaxial, and biaxial) with the same apparatus, it is preferable that more connection points 104 are provided than the number of connection means 106. For example, the connection means 106 are coupled to different connection points 104 in FIGS. 7E and 7D to enable the application of biaxial strain and an intermediate strain path between plane strain and biaxial strain to a specimen, respectively. As such, a change in the configuration of the apparatus to enable the realisation of two or more different strain paths can be facilitated, without the requirement to replace or remove any components of the apparatus.

As described above, the apparatus 100 facilitates a linear strain path in a specimen 300, an isothermal temperature distribution in the test area 330 of the specimen 300 and a constant strain rate during deformation of a specimen. The system described above, either with or without the environmental chamber 500, also facilitates precise control of these conditions. A linear strain path can be controlled by using different lengths and combinations of connection means 106 and connecting them to different connection points 104. The temperature of the specimen 300, both the heating and cooling temperature profile and the subsequent isothermal temperature, can be controlled by the feedback control system 550. Control of the rotation of the output rotatable member 102 enables the application of a constant strain rate to the specimen during deformation.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may be also provided separately or in any suitable sub-combination.

It should be noted that the term “comprising” does not exclude other elements or steps, the term “a” or “an” does not exclude a plurality, a single feature may fulfil the functions of several features recited in the claims and reference signs in the claims shall not be construed as limiting the scope of the claims. It should be noted that the Figures are not necessarily to scale; emphasis instead generally being placed upon illustrating the principles of the present disclosure.

The work leading to this invention has received funding from the European Union Seventh Framework Programme (FP7/2007-2013) under grant agreement number 604240.

1. An apparatus for applying a force to a specimen, the apparatus comprising:
an output rotatable member comprising a plurality of connection points;
a plurality of rigid connection means, each comprising a first end and a second end, wherein the first end of each connection means is pivotably coupled to one of the plurality of connection points of the output rotatable member;
a plurality of guide members; and
a plurality of specimen holders, each slidably mounted to one of the guide members and pivotably coupled to the second end of one of the plurality of connection means.

2. The apparatus of claim 1 further comprising a drive shaft coupled to the output rotatable member.

3. The apparatus of claim 2 further comprising an input rotatable member coupled to the drive shaft.

4. The apparatus of claim 2, further comprising a rigid drive member arranged to rotate the output rotatable member.

5. The apparatus of claim 1, wherein the output rotatable member is a disc.

6. The apparatus of claim 1, wherein there is a first number of connection points and a second number of rigid connection means, and wherein the first number is greater than the second number.

7. The apparatus of claim 6, wherein the connection means are configured to be coupled to different connection points of the plurality of connection points in order to apply two or more different strain paths to a specimen.

8. The apparatus of claim 1, further comprising a rigid base plate.

9. The apparatus of claim 8, wherein the plurality of guide members are coupled to the base plate.

10. The apparatus of claim 8, wherein the base plate comprises a plurality of fixing points arranged to couple to the specimen holders.

11. The apparatus of claim 1, wherein the connection points are distributed in a plane of the output rotatable member.

12. The apparatus of claim 11, wherein the plane of the output rotatable member is perpendicular to an axis of rotation of the output rotatable member.

13. The apparatus of claim 1, wherein each of the plurality of guide members extends in a direction perpendicular to an axis of rotation of the output rotatable member.

14. The apparatus of claim 1, wherein each guide member extends perpendicular to the guide members adjacent to it.

15. The apparatus of claim 1, wherein the plurality of guide members define a plane parallel to the plane of the output rotatable member.

16. The apparatus of any of claim 1, wherein each guide member comprises two rails orientated parallel to one another.

17. The apparatus of claim 1 wherein the plurality of specimen holders hold the specimen.

18. The apparatus of claim 1 further comprising an environmental chamber housing the apparatus.

19. The apparatus of claim 1, further comprising a temperature control for controlling a temperature of the specimen.

20. The apparatus of claim 19, wherein the temperature control is configured to control a heating rate of the specimen and a subsequent cooling rate of the specimen in order to simulate hot forming and cold quenching of the specimen.

21. The apparatus of claim 1, further comprising a measurement system configured to measure a strain in the specimen and/or a force applied to the specimen.

22. The apparatus of claim 21, further comprising at least one sensor configured to sense the force applied to the specimen.

23. The apparatus of claim 22, further comprising at least one sensor configured to sense the strain in the specimen.

24. A method for applying a force to a specimen, the method comprising:
providing an apparatus, the apparatus comprising:
an output rotatable member comprising a plurality of connection points,
a plurality of rigid connection means, each comprising a first end and a second end, wherein the first end of each connection means is pivotably coupled to one of the plurality of connection points of the output rotatable member,
a plurality of guide members, and
a plurality of specimen holders, each slidably mounted to one of the guide members and pivotably coupled to the second end of one of the plurality of connection means;
providing a specimen, wherein the plurality of specimen holders hold the specimen;
rotating the output rotatable member to apply a force to the specimen.

25. The method of claim 24, wherein the step of rotating comprises applying a linear force to a rigid drive member arranged to rotate the output rotatable member.

26. The method of claim 24, the method further comprising:
controlling a temperature of the specimen.

27. The method of claim 26, wherein the apparatus is housed in an environmental chamber, and the step of controlling the temperature of the specimen comprises controlling a temperature within the environmental chamber containing the specimen.

28. The method of claim 26, wherein the step of controlling the temperature of the specimen comprises controlling a heating rate of the specimen and a subsequent cooling rate of the specimen in order to simulate hot forming and cold quenching of the specimen.

29. The method of claim 24, further comprising measuring a strain in the specimen and/or a force applied to the specimen.
